(19) United States
(12) Patent Application Publication
(10) Pub. No.: US 2014/0230040 A1
(43) Pub. Date: Aug. 14, 2014

(54) Validation of Service Management Requests of a Mobile Device in a Geographically Bounded Space

(71) Applicant: INTERNATIONAL BUSINESS MACHINES CORPORATION, Armonk, NY (US)

(72) Inventors: Scott Ryan Crowther, LaGrangeville, NY (US); Grant Douglas Miller, Arvada, CO (US); Nader M. Nassar, Yorktown Heights, NY (US); Tamer Nasser, Hawthorne, NY (US)

(73) Assignee: International Business Machines Corporation, Armonk, NY (US)

(21) Appl. No.: 13/789,048

(22) Filed: Mar. 7, 2013

Related U.S. Application Data
(63) Continuation of application No. 13/763,166, filed on Feb. 8, 2013.

(51) Int. Cl. H04L 29/06

(52) U.S. Cl. CPC H04L 63/0823
USPC 726/10

(57) ABSTRACT

An embodiment of the invention provides a method for disabling at least one application in a mobile device, wherein a communications component of the mobile device receives a request to disable the application and a certificate. The certificate defines a geographic area in which the application is to be disabled. The geographic location of the mobile device is determined with a location component in the mobile device; and, a processor in the mobile device compares the geographic location of the mobile device to the geographic area defined in the certificate to determine whether the geographic location of the mobile device is within the geographic area. The processor validates the certificate to determine whether the request to disable the application is authorized. When the certificate is valid and when the geographic location of the mobile device is within the geographic area, a controller in the mobile device disables the application.

This patent application is a continuation application of U.S. patent application Ser. No. 13/763,166 filed on Feb. 8, 2013, which is hereby incorporated by reference.

### BACKGROUND

The present invention is in the field of systems, methods, and computer program products for validation of service management requests of a mobile device in a geographically bounded space.

Improvements to mobile electronics devices, such as mobile telephones, electronic readers and tablet computers, have led to their widespread use without regard for the location of use. The ability of these mobile electronics devices to be taken and used almost anywhere is very convenient, but there are times and places where use of these devices may be inappropriate or dangerous. Warning signs and announcements are typically used to instruct users to turn off these devices in restricted areas, but compliance with these instructions is primarily left to the user.

### SUMMARY OF THE INVENTION

An embodiment of the invention provides a method for disabling at least one application in a mobile device, wherein a communications component of the mobile device receives a request to disable the application and a certificate. The certificate defines a geographic area in which the application is to be disabled. The geographic location of the mobile device is determined with a location component in the mobile device; and, a processor in the mobile device compares the geographic location of the mobile device to the geographic area defined in the certificate to determine whether the geographic location of the mobile device is within the geographic area. The processor validates the certificate to determine whether the request to disable the application is authorized. When the certificate is valid and when the geographic location of the mobile device is within the geographic area, a controller in the mobile device disables the application.

Another embodiment of the invention provides a method for disabling an application in a mobile device, wherein a communications component of a service center receives a request to disable the application and a certificate, and wherein the certificate defines a geographic area in which the application is to be disabled. The geographic location of the mobile device is determined with a location component in the service center; and, the geographic location of the mobile device is compared to the geographic area defined in the certificate with a processor in the service center to determine whether the geographic location of the mobile device is within the geographic area. The processor also validates the certificate to determine whether the request to disable the application is authorized. A controller in the service center disables the application remotely when the request to disable the application is authorized and when the geographic location of the mobile device is within the geographic area.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a diagram illustrating wireless services negotiation between a mobile device and a service proxy according to an embodiment of the invention;

FIG. 2 is a flow diagram illustrating a method for validating service management requests for a mobile device according to an embodiment of the invention;

FIG. 3 is a flow diagram illustrating a method for disabling an application in a mobile device according to an embodiment of the invention;

FIG. 4 is a flow diagram illustrating a method for disabling an application in a mobile device according to another embodiment of the invention;

FIG. 5 illustrates a device for disabling an application in a mobile device according to an embodiment of the invention;

FIG. 6 illustrates a system for disabling an application in a mobile device according to another embodiment of the invention;

FIG. 7 is a diagram illustrating a system and method for integration according to an embodiment of the invention;

FIG. 8 is a diagram illustrating a system and method for on demand according to an embodiment of the invention;

FIG. 9 is a diagram illustrating a system and method for a virtual private network service according to an embodiment of the invention; and

FIG. 10 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides a system and method for validating service management requests for a mobile device in a geographically bound space. The system can control devices at the operating system (OS) level of the device, which is responsible for managing the device's services (also referred to herein as “applications”). The ability to shut down a service in a device has security and privacy mechanisms put into place. When a signal is sent out from a requestor to shut down a service of the device (e.g., the camera), a certificate is passed along with the signal. The certificate must be approved to allow the organization or person (i.e., requestor) to use this ability. The device validates the certificate prior to allowing the requested shutting down of the service.

The certificate also contains the parameters of a geo-fence that is set up at the time that the certificate was created. When a device receives a signal to shut down a service, the perimeter defined in the certificate must match the perimeter of the geo-fence signal that was separately sent from the location to disable the service. This prevents someone from obtaining a certificate, and using it to disable services in a mobile device at different places.

In order to prevent someone from spoofing both the shutdown signal and the geo-fence so that the credentials match, an additional layer of security (e.g., for banks) includes registering the location with a registry that manually authenticates the information. In this embodiment, the credential, geo-fence, and the registry (which has the credential information) must all match to allow a service in a mobile device to be shut down.

In at least one embodiment of the invention, the validation of the certificate is performed by the mobile device against a certificate authority at the time that the certificate is received from the device sending the signal to disable services. The certificate authority (also referred to herein as a “registry”) can be stored in a memory device on the mobile device (e.g., Flash memory) or in a remote database wirelessly connected to the mobile device. As used herein, the term “connected” includes operationally connected, logically connected, in communication with, physically connected, engaged, coupled, contacts, linked, affixed, and attached. The certificate can be issued to an individual and/or an entity (e.g., building, company, etc.) and can have a date associated with it (e.g., expiration date, specific date such as an event). The certificate, to be created, can be requested by an individual and validated. Then the certificate can be issued by the authority and used by the individual and/or entity.

It is also possible in a malicious attack that multiple, conflicting signals, are present because of the spoofing as described above. In this case, the credentials in the registry can provide the master key to acknowledge the correct signal and geo-fence. Thus, multiple steps can be required to validate a service shutdown request in a mobile device to ensure that the request is not malicious in origin and that the user can trust the request.

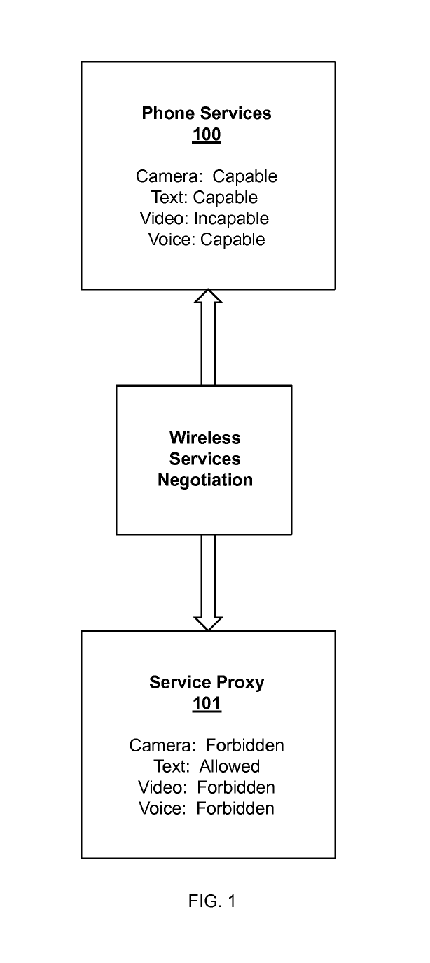

In at least one embodiment of the invention, a mobile device enters an administrative services boundary (also referred to herein as the “perimeter”) and broadcasts a list of capable services. For example, as illustrated in FIG. 1, a cellular telephone 100 broadcasts that is capable of performing the camera, text messaging, and voice recording applications, but that it is not capable of performing a video recording application. In another embodiment, a mobile device only broadcasts its manufacturer and model.

The administrative services boundary refers to any geographically or electronically bounded area that offers administered services oversight for acceptable mobile device functions (privileges). Examples can include a movie theater where video recording is not acceptable, or a confidential meeting where sensitive materials may not be recorded by a mobile device. In at least one embodiment, courtesy functions such as ringtone suppression are implemented for a library when protected within an administrative services boundary. Other examples of administrative services boundaries include a school, church, office, concert pavilion, and sports stadium or arena.

A service proxy 101 acknowledges the cellular telephone 100 and the capable services list. The service proxy 101 also sends a forbidden applications list to the cellular telephone 100. The cellular telephone 100 disables the applications on the forbidden applications list when it is in the administrative services boundary.

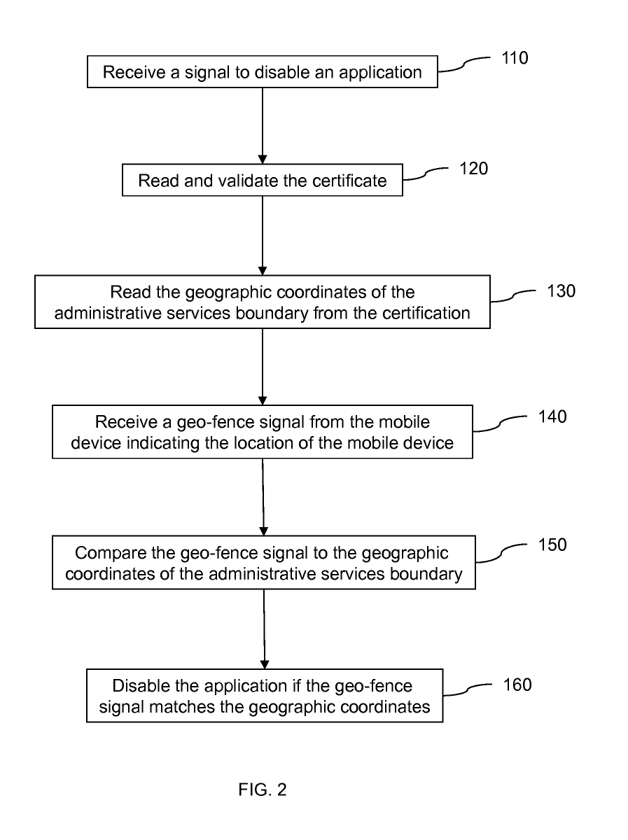

FIG. 2 is a flow diagram illustrating a method for validating service management requests for a mobile device according to an embodiment of the invention. The mobile device receives a signal to disable an application 110. The signal includes a certificate, which is read and validated 120. If the certification is valid, then the geographic coordinates of the administrative services boundary is read from the certification 130.

A geo-fence signal is received from the mobile device indicating the location of the mobile device 140. The geo-fence signal is compared to the geographic coordinates of the administrative services boundary 150. If the geo-fence signal matches the geographic coordinates of the administrative services boundary, then the application listed in the request signal is disabled 160.

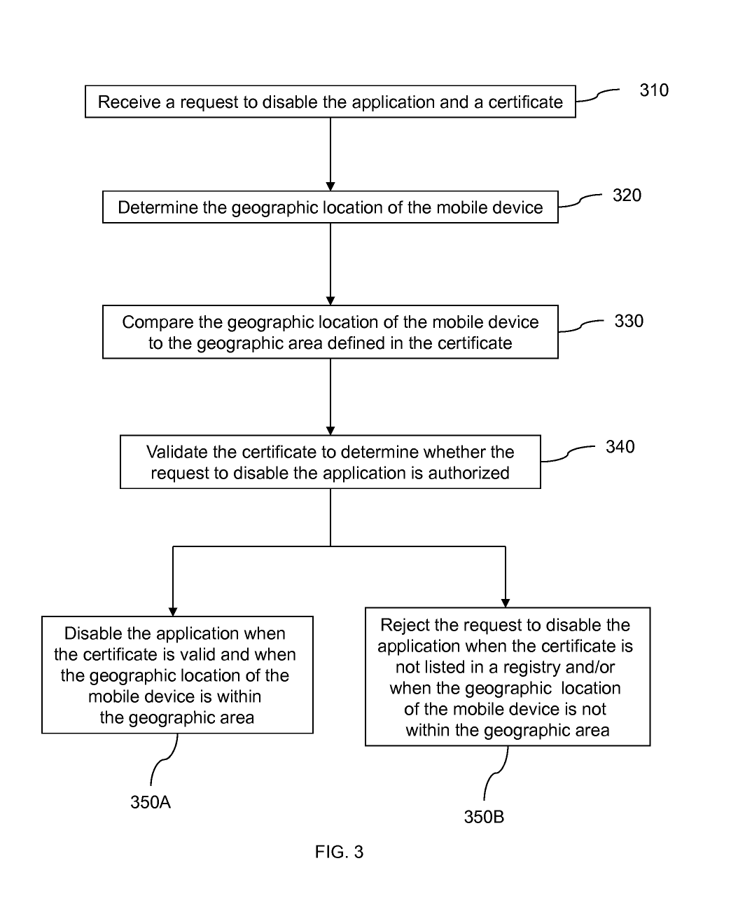

FIG. 3 is a flow diagram illustrating a method for disabling an application (also referred to herein as a “service”) in a mobile device according to an embodiment of the invention. A communications component of the mobile device receives a request to disable (close, shut down) the application and a certificate 310, wherein the certificate (e.g., X.509 certificate) defines a geographic area (e.g., building address) in which the application is to be disabled. Thus, the certificate is only valid for disabling the application in the geographic area. The geographic area can be defined by GPS coordinates, street address(es), zip code(s), area code(s), and/or an area on a map.

In at least one embodiment of the invention, the mobile device is a telephone, an electronic media player, a web-enabled camera, a portable gaming device, a tablet computer, and/or a laptop computer. Examples of the application include, but are not limited to, a camera application, a text messaging application, a picture messaging application, a video messaging application, an internet browser application, a web application, an e-mail application, a telephone application, a communications application, and/or a speaker application.

The geographic location of the mobile device is determined with a location component in the mobile device 320. The geographic area can be identified as GPS coordinates, a street address, a zip code, an area code, and/or a point on a map. A processor in the mobile device compares the geographic location of the mobile device to the geographic area defined in the certificate to determine whether the geographic location of the mobile device is within the geographic area 330. For example, the processor can determine that the mobile device is located in the building at 555 Main Street, which is within the geographic area specified by GPS coordinates in the certificate.

In addition, the processor validates the certificate to determine whether the request to disable the application is authorized 340. In at least one embodiment, this includes querying a registry of valid certificates to determine whether the received certificate is listed in the registry.

The application is disabled with a controller in the mobile device when the certificate is valid (i.e., the request to disable the application is authorized) and when the geographic location of the mobile device is within the geographic area 350A. The request to disable the application is rejected by the processor when the certificate is not listed in a registry of valid certificates and/or when the geographic location of the mobile device is not within the geographic area 350B. Thus, the received certificate must be valid and the certificate must be for the area where the mobile device is located. For example, a certificate for disabling a mobile device in a sports arena may not be valid for disabling a mobile device in a bank. The request to disable the application is rejected with the processor when the certificate is not listed in a registry of valid certificates. In at least one embodiment, the controller controls the operating system of the mobile device.

In another embodiment of the invention, the communications component of the mobile device receives a command to override the disabling of the application. This override command may be used to reactivate the application in case of an emergency event at the geographic location, such as, for example, a fire, police, or medical emergency. In a further embodiment, as part of the reactivation, information regarding the emergency event can be provided. Examples of the information include a description, exit instructions, maps, etc.

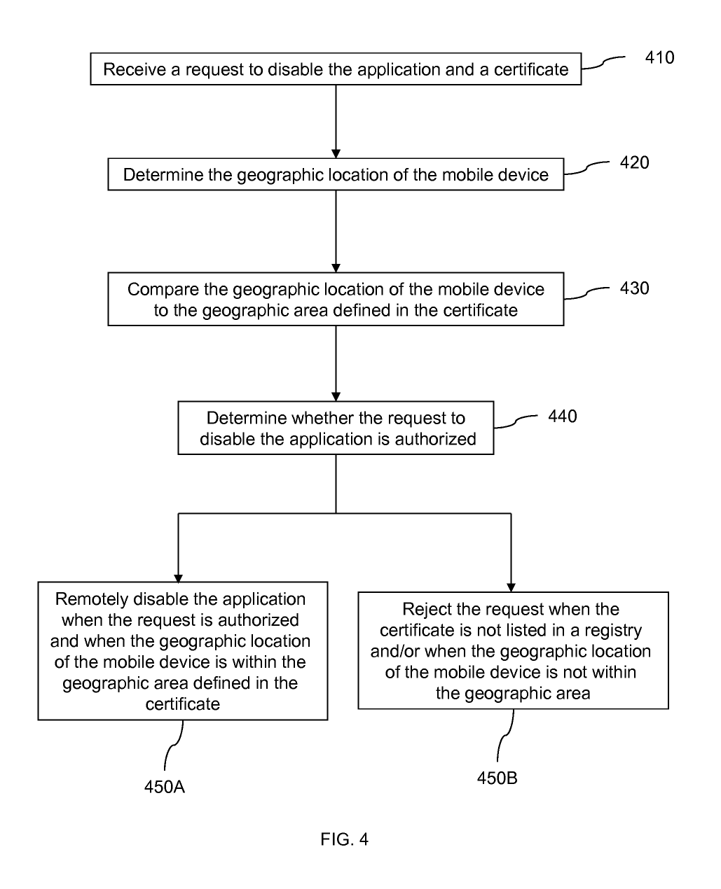

FIG. 4 is a flow diagram illustrating a method for disabling an application in a mobile device according to another embodiment of the invention. A request sent from a third party user to disable the application and a certificate are received in a communications component a service center 410. The certificate defines the geographic area in which the application is to be disabled; thus, the certificate is only valid for disabling the application in the geographic area.

A location component in the service center determines the geographic location of the mobile device 420; and, a processor in the service center compares the geographic location of the mobile device to the geographic area defined in the certificate 430. This is performed in order to determine whether the geographic location of the mobile device is within the geographic area defined in the certificate. The processor also determines whether the request to disable the application is authorized 440. This can be performed by determining whether the certificate is listed in a registry of valid certificates.

The application is remotely disabled with a controller in the service center when the request to disable the application is authorized and when the geographic location of the mobile device is within the geographic area defined in the certificate 450A. The request to disable the application is rejected by the processor when the certificate is not listed in a registry of valid certificates and/or when the geographic location of the mobile device is not within the geographic area 450B.

The application can be disabled remotely by sending a disable command from the controller in the service center (e.g., via the communications component of the service center) to the mobile device. In at least one embodiment of the invention, a request to override the disable command is received (e.g., from a third party user) in the communications component of the service center. The override command can be sent from the controller in the service center to the mobile device, wherein the override command cancels the disable command. Thus, the override command can reactive the application in case of an emergency event at the geographic location.

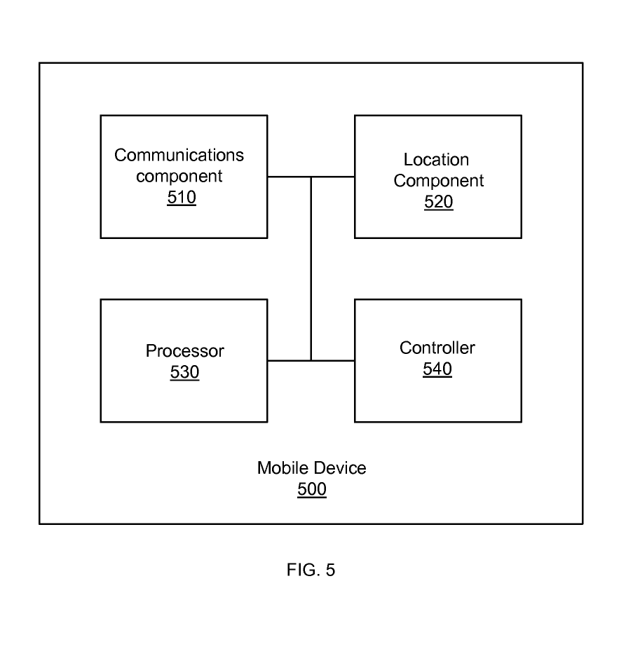

FIG. 5 illustrates a mobile device 500 including at least one application according to an embodiment of the invention, wherein the mobile device can be a telephone, an electronic media player, a web-enabled camera, a portable gaming device, a tablet computer, and/or a laptop computer. The application can be a camera application, a text messaging application, a picture messaging application, a video messaging application, an internet browser application, a web application, an e-mail application, a telephone application, a communications application, and/or a speaker application.

The mobile device includes a communications component 510 and a location component 520. As used herein, the term “communications component” includes a computer hardware device (e.g., antenna) that receives a request to disable the application and a certificate. The certificate defines a geographic area in which the application is to be disabled. Thus, the certificate is only valid for disabling the application in the geographic area, where the geographic area can be defined by GPS coordinates, a street address, a zip code, an area code, and/or a point on a map. In at least one embodiment, the communications component 510 receives a command to override the disabling of the application. As used herein, the term “location component” includes a computer hardware device (e.g., GPS device) connected to the communications component 510 that determines the geographic location of the mobile device.

The mobile device further includes a processor 530 and a controller 540. As used herein, the term “processor” includes a computer hardware device connected to the communications component 510 and/or location component 520 that compares the geographic location of the mobile device to the geographic area defined in the certificate. This is performed to determine whether the geographic location of the mobile device is within the geographic area. The processor 530 can also validate the certificate to determine whether the request to disable the application is authorized. For instance, the processor 530 can determine whether the certificate is listed in a registry of valid certificates.

As used herein, the term “controller” includes a computer hardware device connected to the processor 530 that disables the application when the certificate is valid and when the geographic location of the mobile device is within the geographic area. Specifically, the controller 540 can control the operating system of the mobile device. The controller 540 can reject the request to disable the application when the certificate is not listed in a registry of valid certificates.

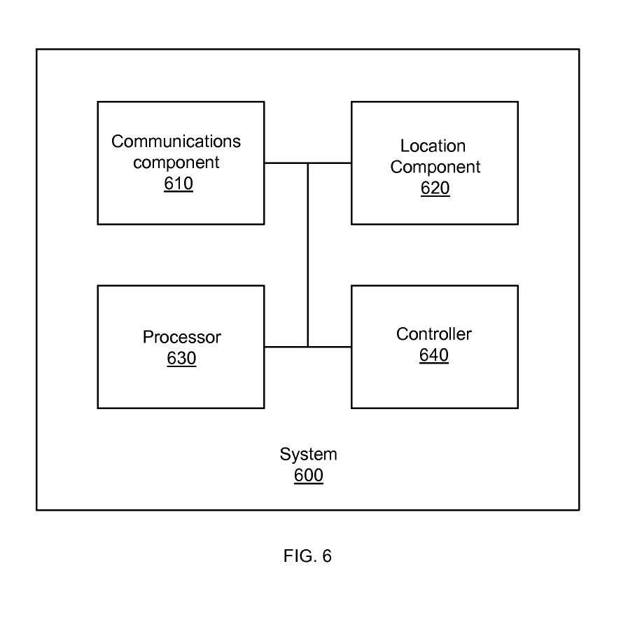

FIG. 6 illustrates a system 600 (also referred to herein as the “service center”) for disabling an application in a mobile device according to an embodiment of the invention, wherein the system 600 includes a communications component 610 connected to a location component 620. As used herein, the term “communications component” includes a computer hardware device in the service center (e.g., antenna) that receives a request to disable the application and a certificate from a requestor. The certificate defines a geographic area in which the application is to be disabled. Thus, the certificate is only valid for disabling the application in the geographic area. As used herein, the term “location component” includes a computer hardware device in the service center (e.g., triangulation devices, GPS locators) that determines the geographic location of the mobile device.

The system 600 further includes a processor 630 connected to a controller 640. As used herein, the term “processor” includes a computer hardware device in the service center that is connected to the location component 610 and/or the communications component 620. The processor 630 compares the geographic location of the mobile device to the geographic area defined in the certificate to determine whether the geographic location of the mobile device is within the geographic area. The processor 630 also validates the certificate to determine whether the request to disable the application is authorized. Specifically, the processor 630 can determine whether the certificate is listed in a registry of valid certificates. When the certificate is not listed in a registry of valid certificates, the processor 630 can reject the request to disable the application.

As used herein, the term “controller” includes a computer hardware device in the service center that disables the application remotely when the request to disable the application is authorized and when the geographic location of the mobile device is within the geographic area. Specifically, the controller 640 can control the operating system of the mobile device by sending a disable command to the mobile device. In at least one embodiment, the communications component 610 receive a request to override (e.g., from the original requestor or from another party), and the controller 640 sends an override command to the mobile device, where the override command cancels the disable command.

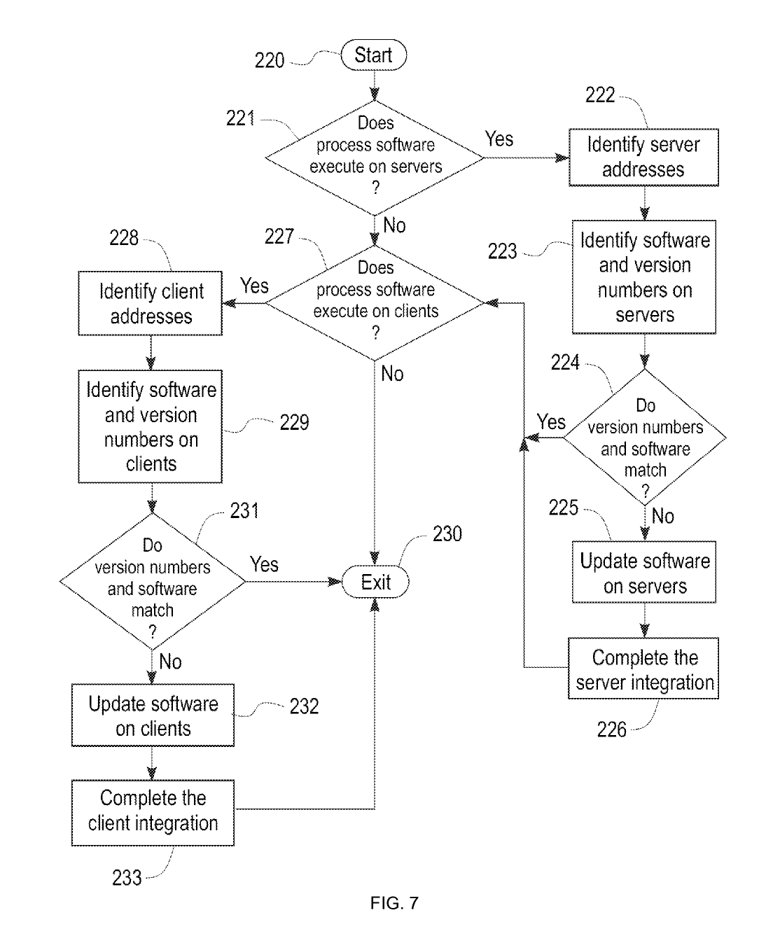

FIG. 7 is a diagram illustrating a system and method for integration according to an embodiment of the invention. The process software is integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

Step 220 begins the integration of the process software. The first thing is to determine if there are any process software programs that will execute on a server or servers 221. If this is not the case, then integration proceeds to 227. If this is the case, then the server addresses are identified 222. The servers are checked to see if they contain software that includes the operating system (OS), applications, and network operating systems (NOS), together with their version numbers that have been tested with the process software 223. The servers are also checked to determine if there is any missing software that is required by the process software 223.

A determination is made if the version numbers match the version numbers of OS, applications and NOS that have been tested with the process software 224. If all of the versions match and there is no missing required software the integration continues in 227.

If one or more of the version numbers do not match, then the unmatched versions are updated on the server or servers with the correct versions 225. Additionally if there is missing required software, then it is updated on the server or servers 225. The server integration is completed by installing the process software 226.

Step 227 which follows either 221, 224 or 226 determines if there are any programs of the process software that will execute on the clients. If no process software programs execute on the clients the integration proceeds to 230 and exits. If this not the case, then the client addresses are identified 228.

The clients are checked to see if they contain software that includes the operating system (OS), applications, and network operating systems (NOS), together with their version numbers that have been tested with the process software 229. The clients are also checked to determine if there is any missing software that is required by the process software 229.

A determination is made is the version numbers match the version numbers of OS, applications and NOS that have been tested with the process software 231. If all of the versions match and there is no missing required software, then the integration proceeds to 230 and exits.

If one or more of the version numbers do not match, then the unmatched versions are updated on the clients with the correct versions 232. In addition, if there is missing required software then it is updated on the clients 232. The client integration is completed by installing the process software on the clients 233. The integration proceeds to 230 and exits.

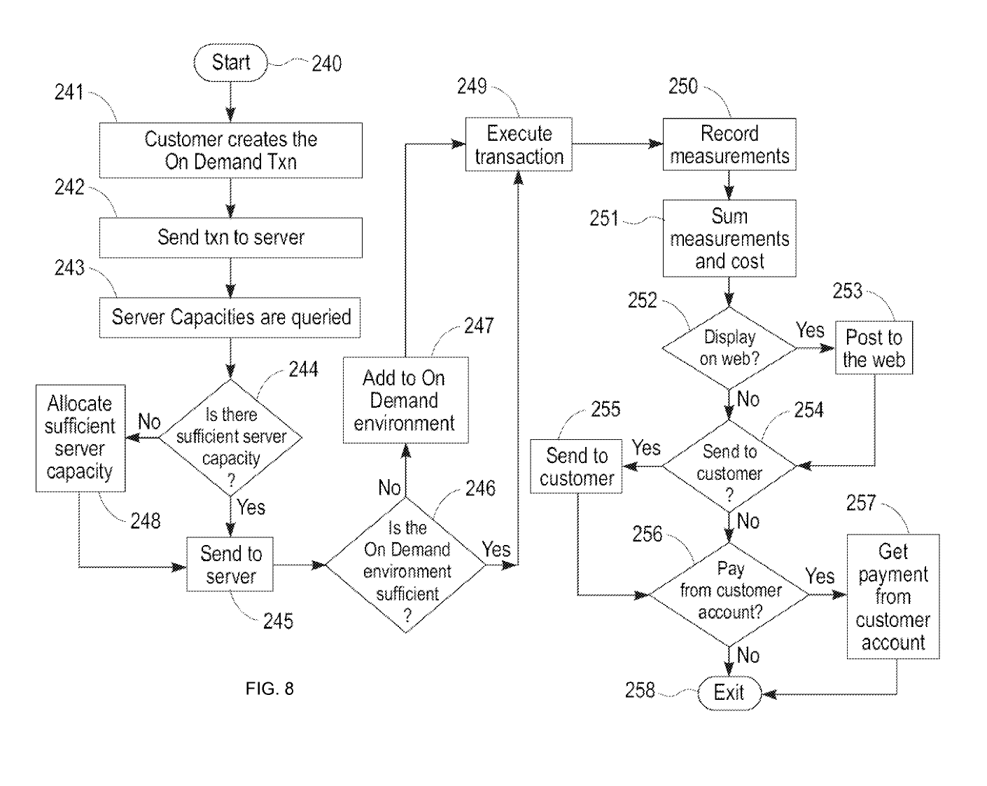

FIG. 8 is a diagram illustrating a system and method for on demand according to an embodiment of the invention. The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements f use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

Step 240 begins the On Demand process. A transaction is created than contains the unique customer identification, the requested service type and any service parameters that further specify the type of service 241. The transaction is then sent to the main server 242. In an On Demand environment the main server can initially be the only server, and then as capacity is consumed other servers are added to the On Demand environment.

The server central processing unit (CPU) capacities in the On Demand environment are queried 243. The CPU requirement of the transaction is estimated, then the server's available CPU capacity in the On Demand environment is compared to the transaction CPU requirement to see if there is sufficient CPU available capacity in any server to process the transaction 244. If there is not sufficient server CPU available capacity, then additional server CPU capacity is allocated to process the transaction 248. If there was already sufficient Available CPU capacity then the transaction is sent to a selected server 245.

Before executing the transaction, a check is made of the remaining On Demand environment to determine if the environment has sufficient available capacity for processing the transaction. This environment capacity consists of such things as but not limited to network bandwidth, processor memory, storage etc. 246. If there is not sufficient available capacity, then capacity will be added to the On Demand environment 247. Next the required software to process the transaction is accessed, loaded into memory, and then the transaction is executed 249.

The usage measurements are recorded 250. The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer 251.

If the customer has requested that the On Demand costs be posted to a web site 252 then they are posted 253. If the customer has requested that the On Demand costs be sent via e-mail to a customer address 254 then they are sent 255. If the customer has requested that the On Demand costs be paid directly from a customer account 256 then payment is received directly from the customer account 257. The last step is exit the On Demand process.

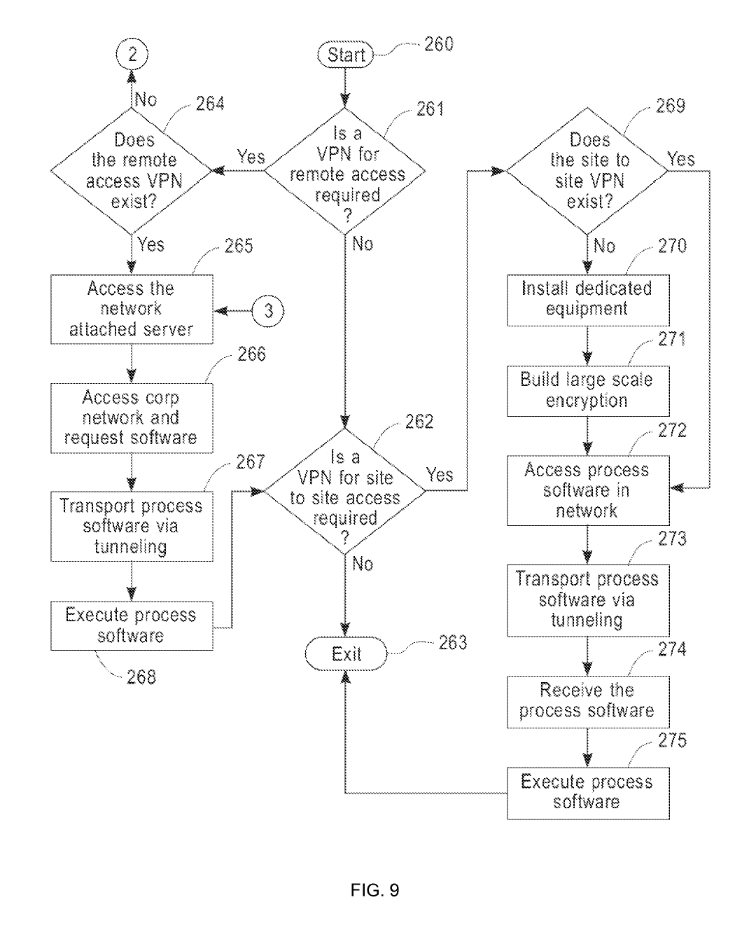

FIG. 9 is a diagram illustrating a system and method for a virtual private network service according to an embodiment of the invention. The process software may be deployed, accessed and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets up a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

Step 260 begins the Virtual Private Network (VPN) process. A determination is made to see if a VPN for remote access is required 261. If it is not required, then proceed to 262. If it is required, then determine if the remote access VPN exists 264.

If it does exist, then proceed to 265. Otherwise identify the third party provider that will provide the secure, encrypted connections between the company's private network and the company's remote users 276. The company's remote users are identified 277. The third party provider then sets up a network access server (NAS) 278 that allows the remote users to dial a toll free number or attach directly via a cable or DSL modem to access, download and install the desktop client software for the remote-access VPN 279.

After the remote access VPN has been built or if it been previously installed, the remote users can then access the process software by dialing into the NAS or attaching directly via a cable or DSL modem into the NAS 265. This allows entry into the corporate network where the process software is accessed 266. The process software is transported to the remote user's desktop over the network via tunneling. That is, the process software is divided into packets and each packet including the data and protocol is placed within another packet 267. When the process software arrives at the remote user's desktop, it is removed from the packets, reconstituted and then is executed on the remote user's desktop 268.

A determination is made to see if a VPN for site to site access is required 262. If it is not required, then proceed to exit the process 263. Otherwise, determine if the site to site VPN exists 269. If it does exist, then proceed to 272. Otherwise, install the dedicated equipment required to establish a site to site VPN 270. Then build the large scale encryption into the VPN 271.

After the site to site VPN has been built or if it had been previously established, the users access the process software via the VPN 272. The process software is transported to the site users over the network via tunneling. That is, the process software is divided into packets and each packet including the data and protocol is placed within another packet 274. When the process software arrives at the remote user's desktop, it is removed from the packets, reconstituted and is executed on the site user's desktop 275. Proceed to exit the process 263.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

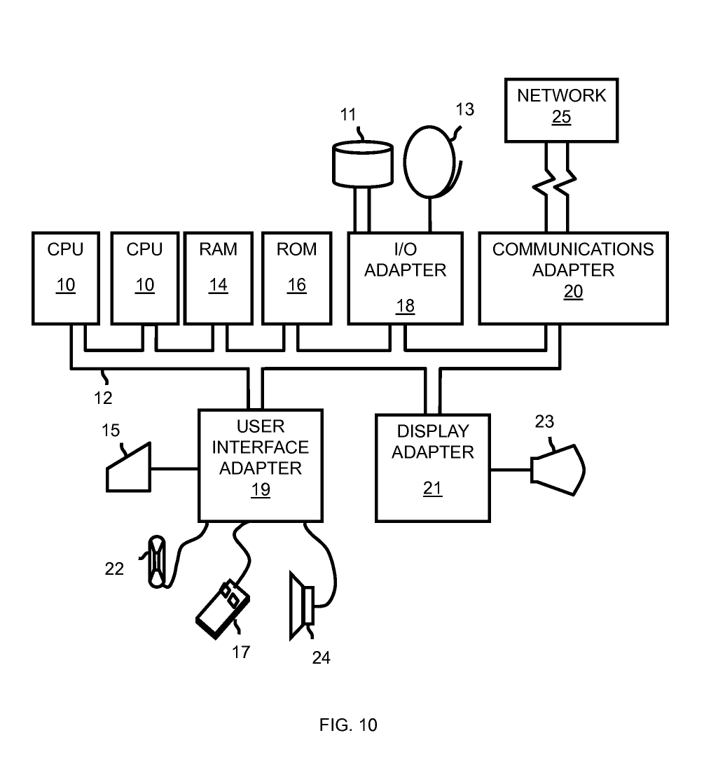

Referring now to FIG. 10, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A mobile device including at least one application, said mobile device comprising:
a communications component, said communications component receives a request to disable the at least one application and a certificate, the certificate defining a geographic area in which the at least one application is to be disabled;
a location component connected to said communications component, said location component determines the geographic location of the mobile device;
a processor connected to said location component, said processor compares the geographic location of the mobile device to the geographic area defined in the certificate to determine whether the geographic location of the mobile device is within the geographic area, said processor validates the certificate to determine whether the request to disable the at least one application is authorized; and
a controller connected to said processor, said controller disables the at least one application when the certificate is valid and when the geographic location of the mobile device is within the geographic area.

2. The mobile device according to claim 1, wherein the controller controls the operating system of the mobile device.

3. The mobile device according to claim 1, wherein the certificate is only valid for disabling the application in the geographic area.

4. The mobile device according to claim 1, wherein the geographic area includes at least one of GPS coordinates, a street address, a zip code, an area code, and a point on a map.

5. The mobile device according to claim 1, wherein said processor determines whether the certificate is listed in a registry of valid certificates.

6. The mobile device according to claim 1, wherein the application includes at least one of a camera application, a text messaging application, a picture messaging application, a video messaging application, an internet browser application, a web application, an e-mail application, a telephone application, a communications application, and a speaker application.

7. The mobile device according to claim 1, wherein the mobile device includes at least one of a telephone, an electronic media player, a web-enabled camera, a portable gaming device, a tablet computer, and a laptop computer.

8. The mobile device according to claim 1, wherein said communications component receives a command to override the disabling of the application.

9. A mobile device including at least one application, said mobile device comprising:
a communications component, said communications component receives a request to disable the at least one application and a certificate, the certificate defining a geographic area in which the at least one application is to be disabled;
a location component connected to said communications component, said location component determines the geographic location of the mobile device;
a processor connected to said location component, said processor compares the geographic location of the mobile device to the geographic area defined in the certificate to determine whether the geographic location of the mobile device is within the geographic area, said processor validates the certificate to determine whether the certificate is listed in a registry of valid certificates; and
a controller connected to said processor, said controller rejects the request to disable the application when the certificate is not listed in a registry of valid certificates.

10. The mobile device according to claim 9, wherein the controller controls the operating system of the mobile device.

11. The mobile device according to claim 9, wherein the certificate is only valid for disabling the application in the geographic area.

12. The mobile device according to claim 9, wherein the geographic area includes at least one of GPS coordinates, a street address, a zip code, an area code, and a point on a map.

13. The mobile device according to claim 9, wherein, in order to disable the application, the certificate must be validated and the certificate must be authorized to disable the application in the geographic location of the mobile device.

14. The mobile device according to claim 9, wherein the application includes at least one of a camera application, a text messaging application, a picture messaging application, a video messaging application, an internet browser application, a web application, an e-mail application, a telephone application, a communications application, and a speaker application.

15. The mobile device according to claim 9, wherein the mobile device includes at least one of a telephone, an electronic media player, a web-enabled camera, a portable gaming device, a tablet computer, and a laptop computer.

16. The mobile device according to claim 9, wherein said communications component receives a command to override the disabling of the application.

17. A system for disabling an application in a mobile device, said system comprising:
a communications component, said communications component receives a request to disable the application and a certificate, the certificate defining a geographic area in which the application is to be disabled;
a location component connected to said communications component, said location component determines the geographic location of the mobile device;
a processor connected to said location component, said processor compares the geographic location of the mobile device to the geographic area defined in the certificate to determine whether the geographic location of the mobile device is within the geographic area, said processor validates the certificate to determine whether the request to disable the application is authorized; and
a controller connected to said processor, said controller disables the application remotely when the request to disable the application is authorized and when the geographic location of the mobile device is within the geographic area.

18. The system according to claim 17, wherein the controller controls the operating system of the mobile device.

19. The system according to claim 17, wherein the certificate is only valid for disabling the application in the geographic area.

20. The system according to claim 17, wherein said processor determining whether the certificate is listed in a registry of valid certificates.

21. The system according to claim 17, wherein the application includes at least one of a camera application, a text messaging application, a picture messaging application, a video messaging application, an internet browser application, a web application, an e-mail application, a telephone application, and a speaker application.

22. The system according to claim 17, wherein the mobile device includes at least one of a telephone, an electronic media player, a web-enabled camera, a portable gaming device, a tablet computer, and a laptop computer.

23. The system according to claim 17, wherein said controller sends a disable command to the mobile device.

24. The system according to claim 19, wherein said controller sends an override command to the mobile device, the override command cancels the disable command.

25. A computer program product for disabling at least one application in a mobile device, said computer program product comprising:
a non-transitory computer readable storage medium;
first program instructions to receive a request to disable the at least one application and a certificate, the certificate defining a geographic area in which the at least one application is to be disabled;
second program instructions to determine the geographic location of the mobile device;
third program instructions to compare the geographic location of the mobile device to the geographic area defined in the certificate to determine whether the geographic location of the mobile device is within the geographic area;
fourth program instructions to validate the certificate to determine whether the request to disable the at least one application is authorized; and
fifth program instructions to disable the at least one application when the certificate is valid and when the geographic location of the mobile device is within the geographic area.
wherein said first program instructions, said second program instructions, said third program instructions, said fourth program instructions, and said fifth program instructions are stored on said computer readable storage medium.
